(19) United States
(12) Patent Application Publication
(10) Pub. No.: US 2023/0129761 A1
(43) Pub. Date: Apr. 27, 2023

(54) ELECTRONIC DEVICE SUPPORT SYSTEM AND METHOD

(71) Applicants: Nilesh N. Kotecha, The Woodlands, TX (US); Maryam Kotecha, The Woodlands, TX (US)

(72) Inventors: Nilesh N. Kotecha, The Woodlands, TX (US); Maryam Kotecha, The Woodlands, TX (US)

(21) Appl. No.: 17/507,998

(22) Filed: Oct. 22, 2021

(51) Int. Cl. A47B 23/04; F16M 11/38

(52) U.S. Cl. CPC A47B 23/043; F16M 11/38

(57) ABSTRACT

A system for positioning of a viewable item includes a base, an extendable arm moveably connected to the base, a device plate connected to the extendable arm, and a retainer connected to the device plate and the item.

### TECHNICAL FIELD

The invention generally relates to supports, and more particularly relates to supports for spatial positioning of electronic devices and other items.

### BACKGROUND

When viewing an electronic display, such as of a tablet or cell phone, or a book or other item, it is often advantageous or desirable to physically position the item relative to the eyes or otherwise. Positioning an item when sitting, reclining or laying can be restrictive or tiresome if the item must be handheld at viewable distance. Tabletops, pillows, the lap or knees and the like allow positioning but not necessarily at optimal angle or perspective. Certain devices, such as laptop computers, desktop monitors, cell phone holders, and others often provide some limited hinged or other movement for positioning. In any event, optimal viewing angle and perspective is desirable.

It would be a significant improvement in the art and technology to provide support systems and methods for positioning electronic devices, books and other items for viewing. It would further be an improvement to provide supports for multi-plane positioning of items. It would also be an improvement to support an item from a fixed structure, such as a chair, bed headboard, or similar structure.

### SUMMARY

An embodiment of the invention is a system for positioning of a viewable item. The system includes a base, an extendable arm moveably connected to the base, a device plate connected to the extendable arm, and a retainer connected to the device plate and the item.

Another embodiment of the invention is a system of a base. The based includes a plate, a groove in an underside of the plate, and an extender sized to generally conform to the groove and slide in and out along the groove.

Yet another embodiment of the invention is a method of displaying an item, including positioning a base connected to an extendable arm, the extendable arm connected to a device plate, and the device plate connected to a retainer, extending the extendable arm relative to the base, positioning the device plate at extent of the extendable arm, and connecting the retainer to the item.

Another embodiment of the invention is a method of manufacture including forming a base, forming a groove in an underside of the base, slidably connecting a stabilizing bar in the groove, connecting an extendable arm to the base, connecting a device plate to the extendable arm opposite the base, and providing a retainer to the device plate.

### BRIEF DESCRIPTION OF THE DRAWINGS

The present invention is illustrated by way of example and not limitation in the accompanying figures, in which like references indicate similar elements, and in which:

FIG. 1 illustrates a right side, top and front perspective view of a system for display of a viewable item, according to certain embodiments of the invention;

FIG. 2 illustrates a right side, top and front perspective view of a base of the system of FIG. 1, according to certain embodiments of the invention;

FIG. 3 illustrates a right side view of a device plate of the system of FIG. 1, according to certain embodiments of the invention;

FIG. 4 illustrates a front view of a extender of the system of FIG. 1, according to certain embodiments of the invention; and

FIG. 5 illustrates a front view of a system of FIG. 1 operating as a clamp, according to certain embodiments of the invention.

### DETAILED DESCRIPTION

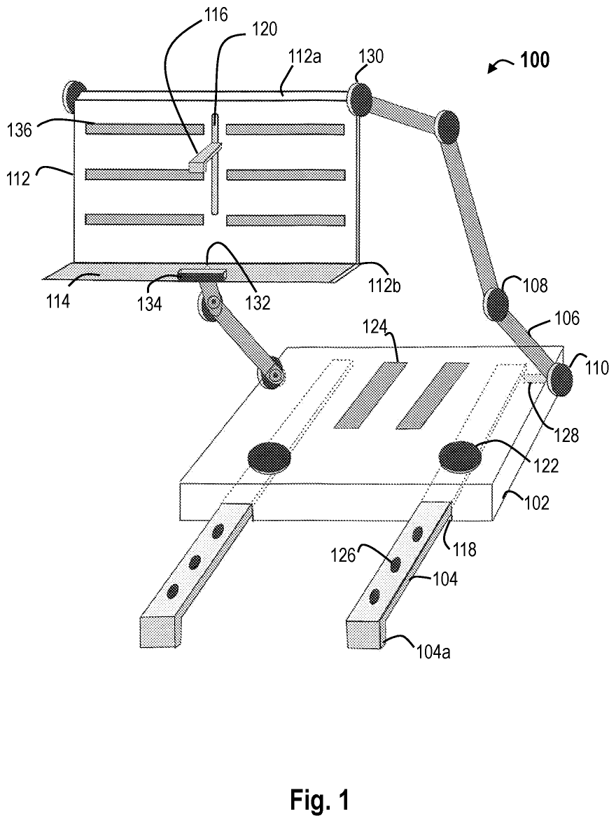

Referring to FIG. 1, a device 100 includes a base 102. The base 102 includes slots 118, such as for nonexclusive example in an under and intermediary portion of the base 102. The slots 118 are sized to accommodate stabilization bars 104 in sliding manner in the slots 118. The base 102 may also include throughways 124 passing from top to bottom of the base 102, such as for nonexclusive example to limit weight and/or materials of the base 102.

The stabilization bars 104, which may be one or more in number, for nonexclusive example two, include one or more holes 126. The bars 104 slide within the slots 118 to extend the effective underside of the base 102. The bars 104 may include end catch 104a at end opposing the base 102. The end catch 104a may be useful to retain the base 102 to a table or the like, by locating the end catch(es) 104a along an edge of a surface.

A lock screw 122 for each stabilization bar 104 includes a threaded male end. A hole through the base 102 includes a female thread hole for receiving the threaded male end of the lock screw 122. If and when the bars 104 are extended from the base 102, the lock screw 122 fits in any of a series of holes 126 extending along the length of the bars 104. The lock screw 122 extends through a respective hole 126 and mates with thread in the base 102 to lock the bar 104 in desired extension from the base 102.

On each side (in FIG. 1) of the base 102, and toward the back (in FIG. 1) of the base 102, a female threaded hole 128 accepts a friction wheel lock 110. A series of extenders 106, such as for nonexclusive example, three extenders on each side of the base 102, are secured to the base 102 at extent of a first extender 106 by the friction wheel lock 110. Each successive extender 106 is secured to prior extender 106 by a friction wheel 108 attached at holes near extent of the prior and successive extender 106.

A final extender 106 of the succession includes a friction screw 130 through the hole near extent of the extender 106 away from the base 102. The friction screw 130 connects to an upper edge 112a of a device holder plate 112. The plate 112 includes a device shelf 114 along a lower edge 112b of the plate 112 opposite the upper edge 112a. Central to the plate 112, the plate 112 forms a throughway segment 120. The segment 120 retains a device lock 116, moveable over the segment 120 and securable in place in the segment 120 by a knob (not shown in FIG. 1). A slot 132 of the shelf 114 accommodates a slidable device holder guard 134. The guard 134 is selectively secured in the slot 132 by a thumb screw (not shown in FIG. 1). The plate 112 may include on an outward face (in FIG. 1) one or more grips 136, such as rubber strip or similar grip.

In operation, the base 102 sits on a surface, lap or area. If the surface or area is generally flat, for example, the area of the understructure of the base 102 can be extended via the stabilization bars 104. The stabilization bars 104 are extendable from the base 102 by unscrewing (at least partially) the lock screws 122 and sliding the stabilization bars 104 along the slots 118, respectively. Once the stabilization bars 104 are positioned at desired extension, the lock screws 122 are screwed to retain the stabilization bars 104 in extended position. Where the base 102 sits on a surface with an edge, the end catch 104a of the stabilization bar 104 may lodge along the edge to retain the base 102 in lateral position.

The extenders 106 are then positioned, via the friction wheel lock 110 and friction wheels 108, to locate the device holder plate 112, and consequently a device positioned thereon, at desired viewing position. Additionally, the plate 112 is angled from the upper edge 112a retained by the friction screw 130, in desired manner of angle for viewing. A device for viewing, for nonexclusive example an electronic display device, is positioned against the plate 112 (or against the rubber grips 136 of the plate 112, as applicable) with an edge of the display device resident on the shelf 114.

The edge of the display device is retained on the shelf 114 by the guard 134. The guard 134 may be slid along the slot 132 to desired position for retaining the display device against the guard 134. Further, the device lock 116 may be positioned via movement along the segment 120 to locate the device lock 116 atop and at edge of the display device. The device lock 116 may be secured in place by the knob (not shown in FIG. 1) on a back side (in FIG. 1) of the plate 112.

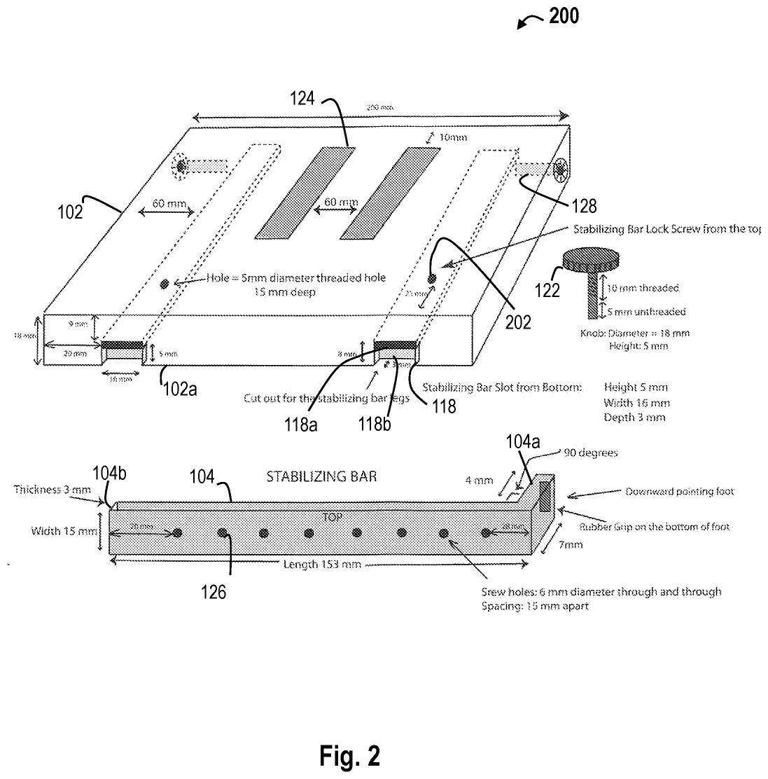

Referring to FIG. 2, a system 200 includes the base 102 and one of the stabilizing bars 104. The base 102 has a bottom 102a of planar or other configuration to conform generally to a surface, such as for nonexclusive example a table, counter, lap, or other surface, which the bottom 102a contacts when the base 102 sits on the surface. The base 102 may in certain nonexclusive embodiments include throughways 124, whether one, two or more. The throughways 124 may limit amount of materials or weight of the base 102. The throughways 124 may also serve to allow attachment of the base 102 and entire system 100 (of FIG. 1) to a headboard, sidearm, or similar vertical fixture as later described.

The base 102 includes two or another number of the slots 118. The slots 118 extend at least a length through the thickness of the base 102. The slots 118 are sized to accommodate an extended end 104b of the stabilizing bar 104. At entry 118a of the slot 118, the base 102 may include an indention 118b sufficient to position the end catch 104a flush with an edge of the base 102 at the slot 118, such as when the stabilizing bar 104 is compressed to extend fully into the slot 118.

The stabilizing bar 104 includes the holes 126 for receiving the lock screw 122 in one or more holes 202 of the base 102 for receiving the lock screw 122. The stabilizing bar 118 may be compressed to the base 102 or extended along the slot 118 to position the stabilizing bar 118 from the base 102. The lock screw 122 retains the stabilizing bar 118 as positioned, when the lock screw 122 in the hole 202 aligns with one of the holes 126 of the bar 118.

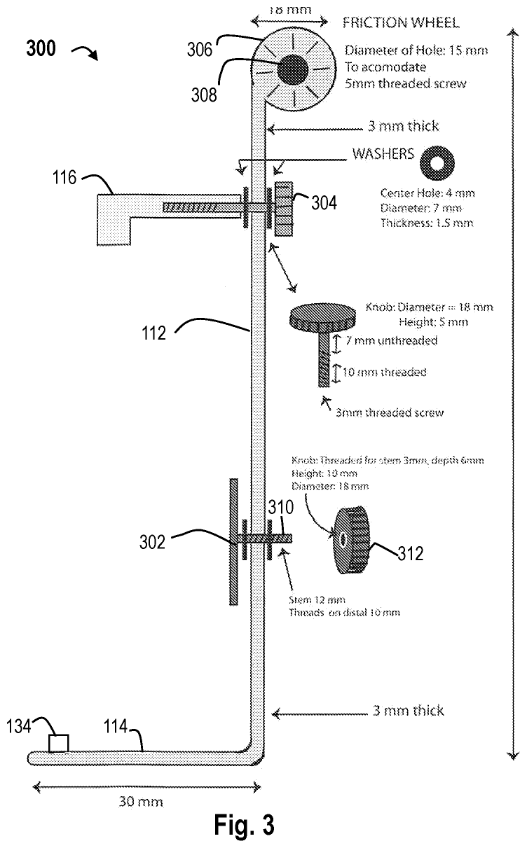

Referring to FIG. 3, a system 300 includes the back plate 112. The back plate 112 includes the shelf 114 extending generally perpendicular to the plate 112 from a bottom end of the plate 112. An upper end of the back plate 112 is connected to, incorporated in or configured with a roll 306 extending along the top edge of the back plate 112. The roll 306 may be relatively solid and includes respective friction wheels 308 at opposing ends of the roll 306 on each side of the back plate 112. The friction wheels 308 connect to respective ends of the extenders 106 opposite the base 102 by the friction screws 130 (in FIG. 1).

The device lock 116 travels on stem of a knob 304 along the segment 120 (shown in FIG. 1) to position, such as vertically or otherwise according to the embodiment, the device lock 116 with respect to the back plate 112. The device lock 116, for non-exclusive example, can contact a top of a display device (not shown) resting on the shelf 114 to retain the device to the plate 112. When the device lock 116 is positioned (vertically or otherwise) in the segment 120, a knob 304 with threaded male counterpart in a threaded female counterpart of the device lock 116 may secure the device lock 116 in place.

In alternatives, the segment 120 or other throughway of the back plate 112 may allow other devices, for non-exclusive example, a magnetic plate 302, to be secured, such as by screw stem 310 coupled with a nut 312. The magnetic plate 302, positioned as desired and secured by the screw stem 310 and nut 312, may retain a display or other device. Further, the plate 112 may include the slot 132 (shown in FIG. 1). In the slot 132, the guard 134 may travel and may be secured or otherwise. The guard 134 may retain a bottom edge of a display device (not shown) sitting on the shelf 114.

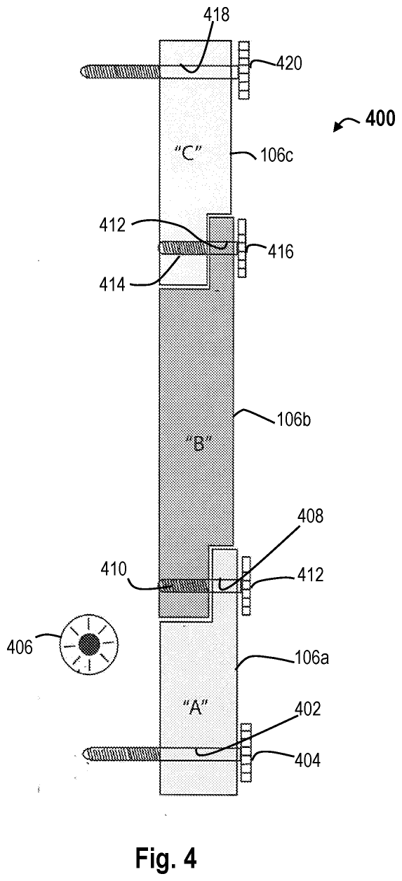

Referring to FIG. 4, a system 400 includes a series of extenders 106, such as for nonexclusive example, three extenders 106a, 106b, 106c. A first extender 106a includes at one extent a hole 402 and the friction wheel lock 110 passes through the hole 402. The friction wheel lock 110 may in use be connected to a corresponding thread of the base 102 (in FIG. 1) to secure the extender 106a to the base 102. A friction wheel 406 is disposed between the extender 106a and the base 102 by the friction wheel lock 110. The first extender 106a may be swung on the friction wheel lock 110 for desired positioning with respect to the base 102.

A second extender 106b is connected to an extent of the first extender 106a opposite the hole 402. Another hole 408 at extent of the first extender 106a allows passage of a screw 412. The second extender 106b similarly at an extent near the first extender 106a includes a threaded hole 410 for receiving the screw 412. One or more friction wheel 406 may be lodged between the first extender 106a and second extender 106b around the holes 408, 410 and/or the hole 408 near the knob of the screw 412. The second extender 106b may be swung on the screw 412 for desired positioning with respect to the first extender 106a.

A third extender 106c is connected to an extent of the second extender 106b opposite the hole 410. Another hole 412 at extent of the second extender 106b allows passage of a screw 416. The third extender 106c similarly at an extent near the second extender 106b includes a threaded hole 414 for receiving the screw 416. One or more friction wheel 406 may be lodged between the second extender 106b and third extender 106c around the holes 412, 414 and/or the hole 412 near the knob of the screw 416. The third extender 106c may be swing on the screw 416 for desired positioning with respect to the second extender 106b. At extent of the third extender 106c opposite the hole 414, the third extender 106c includes a plate hole 418. The friction screw 130 fits through the plate hole 418 and connects to a threaded hole of the friction wheel 308 of the plate 112 (shown in FIG. 3).

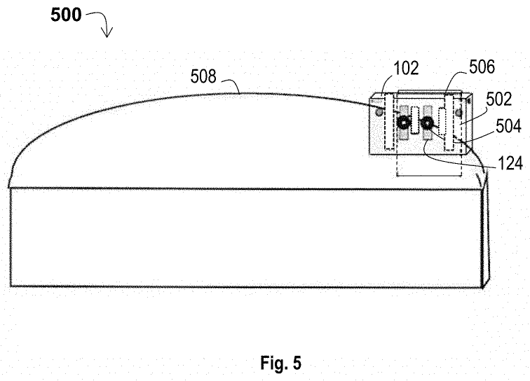

Referring to FIG. 5, a system 500 includes the base 102 and a back plate 502. The back plate 502 is connected to the base 102 by one or more bolts 504. The base 102 and back plate 502, in combination with the bolt 504 and nut (not shown), forms a clamp for fixing the foregoing systems 100, 200, 300, 400 to a headboard 508, sidearm of a chair, table, or other plate or feature of a thickness. A spacer 506 may be positioned between the base 102 and the back plate 502 to vary width of clamping of the combination.

In operation, the bolt 504 is passed through the base 102, for nonexclusive example in the throughways 124. The bolt 504 is also passed through the back plate 502, such as through a hole or slot of the back plate 502. In alternatives, varied width of clamping may be aided or enabled by locating the spacer 506 between the base 102 and the back plate 502, either by passing the bolt 504 through the spacer 506 as located between the base 102 and back plate 502 or otherwise as applicable in the embodiment. The spacer 506 allows clamping between the base 102 and back plate 502 where width is desired in space between the base 102 and back plate 502 when clamped. The nut connects the bolt 504 to the base 102 and back plate 502, with or without spacer 506 as desired, to secure the clamp.

The foregoing devices of a device support are manufacturable of a wide variety of materials. For nonexclusive example, the structures of the devices may be or include any of a wide range of relatively rigid materials that will maintain sufficient structural strength to hold an electronic or other device for display in a desired spatial position in use. Certain materials may include, without limitation, metal, aluminum, tin, iron, composite, hard plastics, and others, including combinations of materials whether any of these or any others. Moreover, the devices may be of varied shape and size and, consequently, elements and features of the devices may be varied in shape and configuration. A wide variety of connection devices, such as for non-exclusive examples screws, bolts, pins, rivets or other retainers may be employed for retaining or joining the relevant elements and features, for movements and positioning. In manufacture, the structures of the devices may be molded, machined, stamped, cut, welded, and otherwise configured. All other possibilities, now or hereafter known or available, are included.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

1. A system for positioning of a viewable item, comprising:
a base;
an extendable arm, the extendable arm includes at least three extenders connected in succession;
a device plate connected to the extendable arm; and
a retainer connected to the device plate and the item;
wherein an end of the extendable arm is pivotally connected to the base and an opposing end of the extendable arm is pivotally connected to the device plate;
wherein the at least three extenders of the extendable arm provide at least three pivot points between the base plate and the device plate.

2. The system of claim 1, further comprising:
a groove in a side of the base; and
a bar slidably connected to the groove.

3. The system of claim 1, wherein the extendable arm includes a retractable series of interconnected structures.

4. The system of claim 2, wherein the extendable arm includes a retractable series of interconnected structures.

5. The system of claim 1, further comprising:
a ledge of the device plate; and
wherein the retainer of the device plate; is configured for selectively retaining a display.

6. The system of claim 5, further comprising:
a groove in a side of the base; and
a bar slidably connected to the groove.

7. The system of claim 5, wherein the extendable arm includes a retractable series of interconnected structures.

8. The system of 6, wherein the extendable arm includes a retractable series of interconnected structures.

9. A system, comprising:
a plate;
a groove in an underside of the plate; and
an elongate stabilizing bar sized to generally conform to the groove and slide in and out along the groove;
an extendable arm moveably connected to the plate, the extendable arm includes at least three interconnected structures connected end to end in succession;
a device plate moveably connected to the extendable arm; and
a retainer connected to the device plate configured to retain a display.

10. (canceled)

11. A method of displaying an item, comprising:
positioning a base connected to an end of an extendable arm of at least three pivotally interconnected segments, the extendable arm connected at another end to a device plate, and the device plate connected to a retainer;
extending the extendable arm relative to the base;
positioning the device plate at an extent of the extendable arm; and
connecting the retainer to the item.

12. The method of claim 11, further comprising:
extending a stabilizing bar slidably connected to a groove in a side of the base.

13. A method of manufacture, comprising:
forming a base;
forming a groove in an underside of the base;
slidably connecting a stabilizing bar in the groove;
connecting an end of an extendable arm to the base, the extendable arm includes at least three pivotally interconnected segments;
connecting a device plate to another end of the extendable arm opposite the base; and
providing a retainer to the device plate.

14. The method of manufacture of claim 13, further comprising:
forming a ledge of the device plate.

15. The method of manufacture of claim 13, wherein the extendable arm is a series of successive interconnected structures which extend and contract.
